(19) United States
(12) Patent Application Publication
(10) Pub. No.: US 2006/0187821 A1
(43) Pub. Date: Aug. 24, 2006

(54) Network terminal apparatus, communication overload avoiding method and program

(76) Inventors: Takahiro Watanabe, Moriguchi-shi (JP); Takayuki Hamaki, Kyotanabe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/527,024

(22) PCT Filed: Dec. 22, 2003
(86) PCT No.: PCT/JP03/16437

§ 371 Date: Mar. 8, 2005

(30) Foreign Application Priority Data
Dec. 26, 2002 (JP) 2002-378555

(51) Int. Cl. H04L 12/26

(52) U.S. Cl. 370/229

(57) ABSTRACT

A network terminal apparatus of the present invention includes an overload condition detecting unit detecting communication overload condition and an overload condition completion detecting unit detecting recovery from an overload condition, invalidates data received by LAN chip when an overload condition is detected, and releases said invalidation when recovery from an overload condition is detected.

### TECHNICAL FIELD

The present invention relates to a network terminal apparatus eliminating negative impact caused by communication overload condition, and particularly to a network terminal apparatus processing video data at home.

### BACKGROUND ART

In general, a communication overload condition of a network terminal apparatus connected to the IP network causes excessive communication processing load on the IP layer and the lower layers of a network terminal apparatus, resulting in significant occupancy of CPU processing capability by communication processing, which impacts negatively not only on communication processing but also on the other processing.

Also a Denial of Service attack (DoS attack) can be considered as one of the causes of overload communication condition. An example of a technique to prevent communication overload caused by such DoS attack is the illicit access defense system described in Japanese Laid-Open Patent application No. 2002-158660 publication. As shown in FIG. 8, the system is configured to filter Internet Protocol (IP) packets at attacker's routers (Attack breaker 100 and 200), in a case where Communication Control Device 3 notices a direction of communication control to the attacker's network according to a judgment by a network administrator when a DoS attack is detected by an Attack Detection Device 2, in the configuration. This configuration enables to prevent communication overload condition.

However, the above-mentioned conventional technique requires the judgment by a network administrator possessing specialized knowledge and also additional devices equipping a filtering function to attacker's network, which makes it difficult to apply to home consumer network apparatuses.

Furthermore, when the CPU of the network apparatus processing video data is occupied by communication processing due to communication processing overload, negative impact delaying the major processing (video data processing and so on) other than communication processing occurs, and a user may misunderstand the condition as a failure. Especially, since video data processing requires real-time processing, negative impact caused by communication overload condition must be completely eliminated.

An object of the present invention is to provide a network terminal apparatus that enables smooth processing of the main apparatus which includes the network terminal, preventing communication overload condition without user's judgment or external additional devices.

### DISCLOSURE OF INVENTION

In order to achieve the above-mentioned object, a network terminal apparatus of the present invention includes a communication unit to communicate through a network, a judgment unit to judge whether or not the communication is in an overload condition and an invalidation unit to invalidate data received by the communication unit in the case where the judgment is that the communication is in an overload condition.

With this configuration, the received data is invalidated under an overload condition. Therefore, the negative impact to the communication processing and the other processing can be eliminated even under a communication overload condition without user's judgment or additional devices. In fact, the receiving processing does not occupy the processing capability of the CPU, and it is possible to continue the other processing without degrading the quality. Therefore, the present invention is readily applicable to the network terminal apparatus used at home and other processing can be executed smoothly. For instance, as another processing other than communication processing, even the network terminal apparatus executing video data processing requiring real-time processing can eliminate the negative impact caused by a communication overload condition. Actually, in the case where the judgment is that the communication is in an overload condition, the received data is blocked like a circuit breaker without checking the types or the contents of the received data, hence the processing in the network terminal apparatus can be protected by a simple configuration which does not require user's setting.

Under this configuration, the judgment unit may be configured to judge that the communication is in an overload condition in the case where an amount of data received per unit time from the network exceeds a threshold.

The judgment unit may be also configured to judge that the communication is in an overload condition in the case where an amount of data received in a receiving buffer that temporarily holds the received data exceeds the threshold.

With this configuration, the overload condition can be judged immediately using the threshold for an amount of the received data.

The judgment unit may be also configured to judge the received data in communication processing corresponding to the data link layer using the threshold.

With this configuration, the threshold judgment is carried out on the level of the data link layer, therefore the network layer and the upper layers are not negatively impacted by load caused by threshold judgment.

Furthermore, the network terminal apparatus may be configured to equip a determination unit to dynamically determine the threshold depending on a load condition of a processing other than the communication processing in the network terminal apparatus, and the judgment unit judges whether or not the communication is in an overload condition using the determined threshold.

With this configuration, the threshold is dynamically determined, therefore the communication overload condition can be changed dynamically depending on the size of a load of a processing other than the communication processing in the network terminal apparatus. Accordingly, the negative impact to processing requiring real-time processing other than the communication processing in the network terminal apparatus can be eliminated, and processing capabilities of the whole network terminal apparatus can be maximized.

Additionally, the determination unit may be configured to determine the threshold depending on the number of running application programs in the network terminal apparatus.

The determination unit may be also configured to determine the threshold depending on (i) the number of running application programs in the network terminal apparatus and (ii) a weight predetermined with respect to each application program.

With the configuration, the dynamic threshold determination can be readily carried out depending upon the number of running application programs. Moreover, a weighting to the number of each application program enables to set up an appropriate threshold depending on a load of a processing of the running application.

The communication unit includes a first communication processing unit to execute a communication processing corresponding to the physical layer and the data link layer, a receiving buffer to temporarily hold received data from the first communication processing unit and a second communication processing unit to take the received data from the receiving buffer and execute communication processing corresponding to the network layer and the upper layers. The judgment unit may be configured to judge the communication to be in an overload condition in the case where an amount of the received data in the receiving buffer exceeds the threshold.

With the configuration, an overload condition is detected by communication processing in the second communication processing unit (e.g. IP processing).

The communication unit may be configured to execute hierarchical communication processing and the invalidation unit prohibits one of the interlayer logical connection.

With this configuration, the load on the communication processing layer, which locates above the layers where connection being prohibited, is eliminated and the processing load on the processing in the network terminal apparatus other than communication processing is eliminated as well. Hence, the processing other than communication processing are not negatively impacted under a communication overload condition.

The invalidation unit may be configured to prohibit the first communication processing unit from notifying the second communication processing unit of received data.

With the configuration, the invalidation unit enables to eliminate the load of communication processing in the network layer and the upper layers under a communication overload condition just by prohibiting the notification of the received data. When the processing in the second communication processing unit is realized by software and the CPU, the load of communication processing to the CPU can be eliminated.

The network terminal apparatus in the present invention may also be configured to equip the communication unit to communicate through a network, a first detection unit to detect that the communication is in an overload condition, an invalidation unit to invalidate data received by the communication unit in the case where an overload condition is detected, a second detection unit to detect a recovery from the overload condition, and a release unit to release the invalidation by the invalidation unit when a recovery from the overload condition is detected.

In addition, a communication overload condition avoiding method in the present invention and its program have the same unit with the above-mentioned network terminal apparatus, and the same functions and effects are secured.

### BRIEF DESCRIPTION OF DRAWINGS

FIG. 1 shows a major hardware configuration of a network terminal apparatus (a communication overload condition avoiding apparatus) in the embodiment of the present invention.

FIG. 2 is a block diagram showing the functions of major units of the communication overload condition avoiding apparatus.

FIG. 3 is a flowchart showing a detailed example of communication overload condition detection processing performed in the overload condition detecting unit.

FIG. 4 is a flow chart showing a detailed example of how the overload condition completion detecting unit detects the completion of an overload condition.

FIG. 5 is a table showing correspondence between the number of applications being executed and respective thresholds.

FIG. 6A is a table showing correspondence between applications and the respectively corresponding weighting values.

FIG. 6B is a table showing other correspondences between applications and the respectively corresponding weighting values.

FIG. 7 shows a system example including a home appliance applying a communication overload condition avoiding apparatus.

FIG. 8 shows the configuration of an illicit access defense system in a conventional technique.

### BEST MODE FOR CARRYING OUT THE INVENTION

[Hardware Configuration of a Communication Overload Condition Avoiding Apparatus]

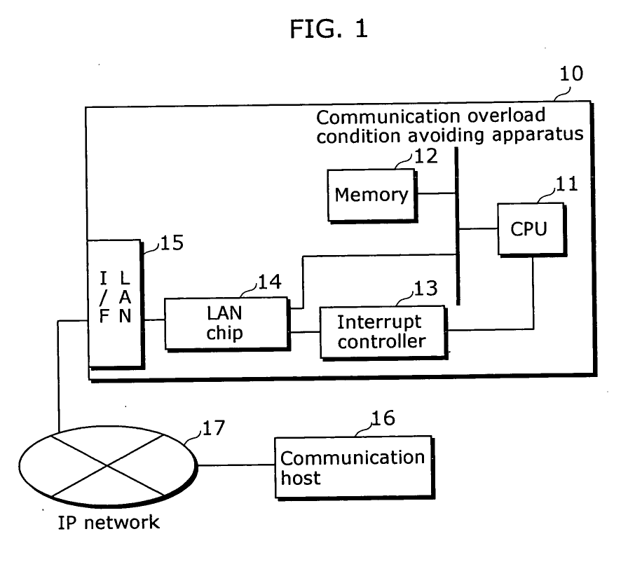

FIG. 1 shows a major hardware configuration of a network terminal apparatus in the embodiment of the present invention. This network terminal apparatus is called communication overload condition avoiding apparatus 10 in the figure, includes a Central Processing Unit (CPU) 11, a memory 12, an interrupt controller 13, a LAN chip 14 and a LAN I/F (interface) 15 and communicates with a communication host 16 and so on through the Internet Protocol (IP) network 17.

This hardware configuration is a general configuration and the memory 12, having an area as a receiving buffer used temporarily for storing data received, stores a program describing communication overload condition avoiding method in the present invention. The CPU 11 judges whether or not the condition being in communication overload by executing this program. The communication overload condition avoiding apparatus 10 is configured so that it can cancel the data received when the CPU 11 judges the condition as overload. The communication overload condition herein means a state that processing (for example, video data processing requiring real-time processing) other than communication in the communication overload condition avoiding apparatus 10 are not executed properly.

Firstly, the operations performed by the hardware at the time of receiving data under communication non-overload condition (hereafter, called steady state) will now be explained.

LAN chip 14 is, for example, a controller, which conforms to the Institute of Electrical and Electronic Engineers (IEEE) 802.3 standard (called as Ethernet (R)), executing communication processing of data link layer and a part of physical layer. When the LAN chip 14 receives a frame (called as Ethernet (R) frame) to its own address through the LAN I/F 15, the LAN chip 14 notifies the interrupt controller 13 of the fact accordingly. When the interrupt controller 13 received this notice, the interrupt controller 13 causes reception interrupt to the CPU 11 further. The reception interrupt is an interrupt notifying the presence of data received.

After receiving the reception interrupt, the CPU 11 reads the data received by the LAN chip 14 out of the buffer in the LAN chip 14 and transfers to the memory 12, followed by IP processing. On this occasion, under a steady state, the CPU 11 executes detection processing of communication overload condition by checking the amount of data received per unit time by executing a program in the memory 12.

Secondly, operation in hardware at the time of detecting, avoiding and recovering from a communication overload condition (hereafter, also called unsteady state) will now be explained.

Assuming that the communication host 16 starts a large amount of communication to the network terminal apparatus 10. When the CPU 11 detects a communication overload condition, masks interrupt signal from the LAN chip 14 to the interrupt controller 13. This eliminates the occurrence of reception interrupt of Ethernet (R) to the CPU 11 and communication overload condition can be avoided.

In an unsteady state, the CPU 11 executes processing of detecting completion of an overloaded condition by executing a program in the memory 12, and cancels the above-mentioned interrupt mask to the interrupt controller 13 upon detecting the completion of an overload condition. Accordingly, this realizes a recovery from unsteady state to steady state. This hereinbefore explained is the outline of the operation in hardware.

[Functional Configuration of the Communication Overload Condition Avoiding Apparatus]

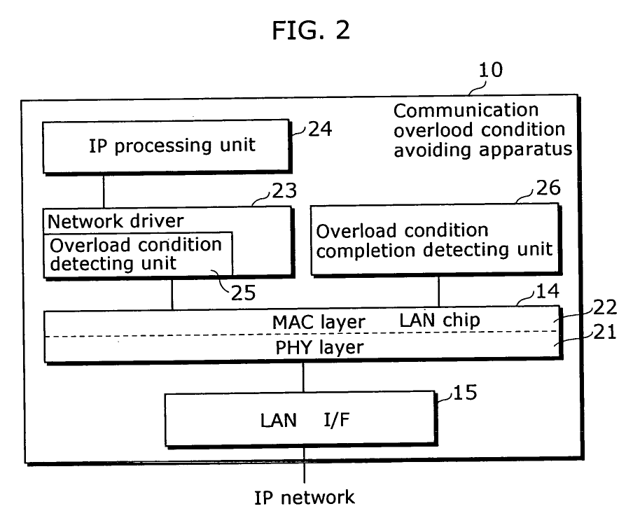

FIG. 2 is a block diagram showing the functions of major units of the communication overload condition avoiding apparatus 10 shown in FIG. 1. The communication overload condition avoiding apparatus 10 includes a LAN chip 14, a LAN I/F 15, a network driver 23, an Internet Protocol (IP) processing unit 24, an overload condition detecting unit 25 and an overload condition completion detecting unit 26. The numbers of each unit are matched to the same unit in FIG. 1.

The LAN chip 14 executes communication processing in both the PHY layer 21 corresponding to a part of the physical layer and the MAC layer 22 corresponding to a part of the data link layer in the Open System Interconnection (OSI) reference model.

The LAN I/F 15, as processing for a part of the physical layer, functions to conform a frame to be communicated between the LAN chip 14 and the IP network to the electrical specification of the LAN chip 14.

The network driver 23, in a steady state, executes communication processing for a part of the data link layer. This communication processing is usual processing as a device driver, and includes data transmission from the LAN chip 14 to the memory 12 executed in response to reception interrupt explained in FIG. 1. The network driver 23 is, in an unsteady state, substantially prohibited from executing processing because an interrupt signal is masked.

The IP processing unit 24, in a steady state, executes IP processing on the data received by and sent from the network driver 23.

The overload condition detecting unit 25, in a steady state, judges the state being in communication overload condition when the amount of the data received per unit time exceeds a threshold, and then masks an interrupt signal being transmitted from the interrupt controller 13 to the CPU 11.

The overload condition completion detecting unit 26, in an unsteady state, executes polling processing to check the presence of received frames in a buffer of the LAN chip 14. When the state where the received frame is not present continues for a predetermined period, the overload condition completion detecting unit 26 judges overload condition being completed and releases the above-mentioned interrupt mask to the interrupt controller 13.

The above-mentioned overload condition detecting unit 25 executes a measurement and carries out the threshold judgment by the result of the measurement. With respect to specific methods by the overload condition detecting unit 25 for judging whether or not the data received per unit time exceeds a threshold, the result of the measurement such as the amount of the data received (e.g. the number of bits, bytes, frames, IP packets and so on) for a predetermined duration (e.g. 10 ms), or the duration required for receiving the fixed amount of data (e.g. the number of any of bits, bytes, frames or IP packets) may be used.

[A Detailed Flow of Communication Overload Condition Detecting Processing]

The example of the threshold judgment by a measurement result of the duration required for receiving a fixed amount (the number of frames: W) of data received, which is one of the specific example for judging whether or not the data received per unit time exceeds the threshold performed by the overload condition detecting unit 25, will now be explained.

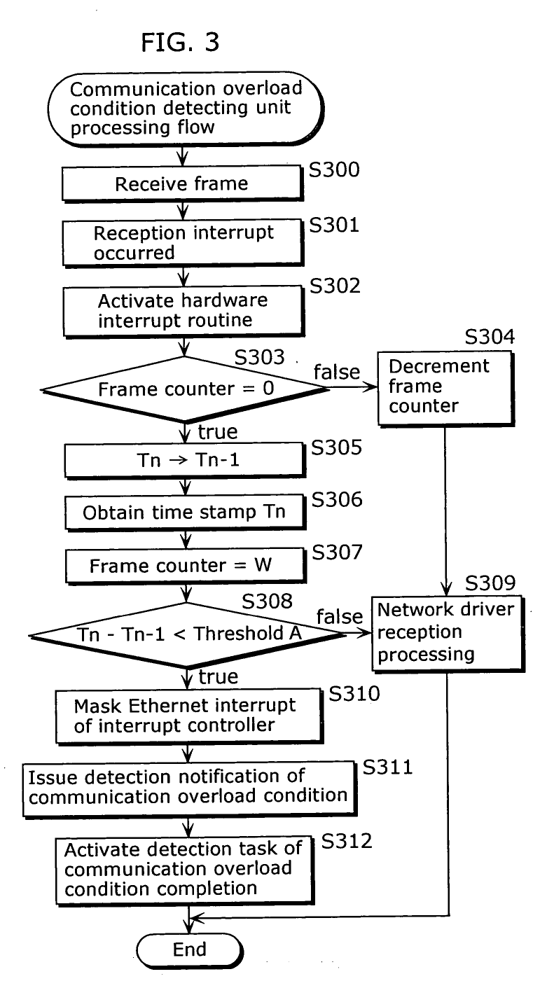

FIG. 3 is a flowchart showing a detailed example of communication overload condition detection processing performed by the overload condition detecting unit 25. S300 to S302 and S309 in the flowchart are not involved in the communication overload condition detecting processing performed by the overload condition detecting unit 25, but S300 to S302 show the processing until the step of activating communication overload condition detecting processing by reception interrupt in FIG. 1 and S309 shows the communication processing by the network driver 23 respectively.

A frame counter in the figure functions to count W of frames and carries out countdown from W to zero. A time stamp Tn, a resister, functions to hold time obtaining from a real-time clock in the communication overload condition avoiding apparatus 10, and shows the time when the current frame is received. A time stamp Tn-1, a resister, functions to hold the receiving time of the frame W before the current frame. Tn-Tn-1 expresses the duration of the interval required to receive W of frames. Threshold A is an indication used to judge whether or not the interval (Tn-Tn-1) is too short (in an overload condition). The threshold A is set up not to impact negatively on other processing in the communication overload condition avoiding apparatus 10 by communication processing. Additionally, the default value for the frame counter, the time stamp Tn and the time stamp Tn-1 are all zero.

When the LAN chip 14, in a steady state, receives a frame (S300) through the LAN I/F 15, the LAN chip 14 causes a reception interrupt (S301) by way of the interrupt controller 13. The CPU 11 received this fact subsequently activates the overload condition detecting unit 25 by calling a program corresponding to the overload condition detecting unit 25 (S302).

Processing afterward are individually explained in two different cases i.e. in the case of initial frame reception and in the case of a second time thereafter.

In the case of initial frame reception, the overload condition detecting unit 25, as the frame counter showing zero (S306), assigns the value of the time stamp Tn to Tn-1 (S305) and obtains the current time from the real time clock as a value for the time stamp Tn (S306), then sets up a start-up value W to the frame counter (S307). According to this, as a preparation for receptions from the second time thereafter, the time stamp Tn is updated to the current frame reception time and the value of the frame counter is updated to W respectively. The value of Tn-1 remains zero. Moreover, since (Tn-Tn-1) exceeds the threshold A (S308), the overload condition detecting unit 25 activates the network driver 23 and causes it to execute reception processing (S309).

In the case of the second time thereafter for frame receptions, unless the frame counter shows zero, in other words, unless the overload condition detecting unit 25 has not received W of frames (S303: false), the overload condition detecting unit 25 decrements the frame counter (S304) and activates the network driver 23 to make it execute reception processing (S309).

On the other hand, when the frame counter shows zero, in other words, when the overload condition detecting unit 25 has received W of frames (S303: true), the overload condition detecting unit 25 assigns a value of the time stamp Tn to Tn-1 (S305). According to this, the time stamp Tn-1 shows the reception time of the frame, which is W frames before. Furthermore, the overload condition detecting overload condition detecting unit 25 obtains the current time from the real time clock, and sets up the value of the time stamp to Tn as the current frame received time. When a duration of the interval (Tn-Tn-1) is less than the threshold A (S308: true), the overload condition detecting unit 25 masks an interrupt signal of the interrupt controller 13 (S310), and subsequently notifies a detection of communication overload condition to the CPU 11 (S311), then activates the overload condition completion detecting unit 26 (S312).

The interrupt mask blocks the notification of an interrupt being sent from the interrupt controller 13 to the CPU 11. Afterward, hardware interrupt processing related to LAN communication does not occur and the network driver 23 and the overload condition detecting overload condition detecting unit 25 are not activated. Alternatively, a task of communication overload condition completion detecting processing is executed.

On the other hand, when the duration of the interval (Tn-Tn-1) is not less than the threshold A (S308: false), which is not overload condition, the overload condition detecting unit 25 activates the network driver 23 to make it execute the reception processing (S309).

[Threshold Example]

The above-mentioned threshold A may be set up (initial value W of frame counter, threshold A) as (85 frames, 10 ms) or (170 frames, 20 ms) in the case where the LAN transmission speed is 100 Mbps, although it depends on the capacity of the CPU 11. And also (8 frames, 10 ms) or (17 frames, 20 ms) may be set up in case of 10 Mbps. The set-up value of the threshold A should be sufficiently longer duration than the maximum time of typical burst frame reception.

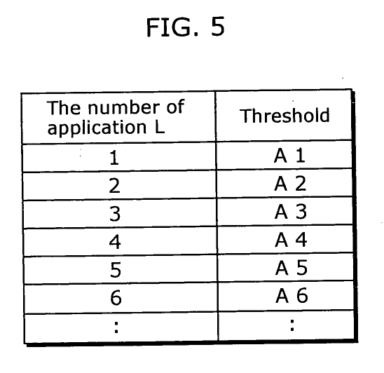

The aforementioned threshold value A can be dynamically determined depending upon the condition of processing load other than the communication in the communication overload condition avoiding apparatus 10. In that case, the threshold A may be determined in the step between S307 and S308 in FIG. 3. In this threshold determination step, the overload condition detecting unit 25, for example, determines the threshold corresponding to the number of running applications as the threshold A for the judgment by predetermining multiple thresholds A1, A2 . . . to be corresponded to the number of running applications L by the CPU 11 as shown in FIG. 5.

This dynamic threshold determination enables dynamic change of the throughput where communication processing can occupy the processing capacity in the CPU 11, and the dynamic definition of communication overload condition depends on the processing load is heavy or light other than communication processing in the communication overload condition avoiding apparatus 10. Therefore, negative impact on processing requiring real-time processing other than communication processing in the communication overload condition avoiding apparatus 10 can be eliminated, moreover the processing capability of the whole communication overload condition avoiding apparatus 10 can be maximized.

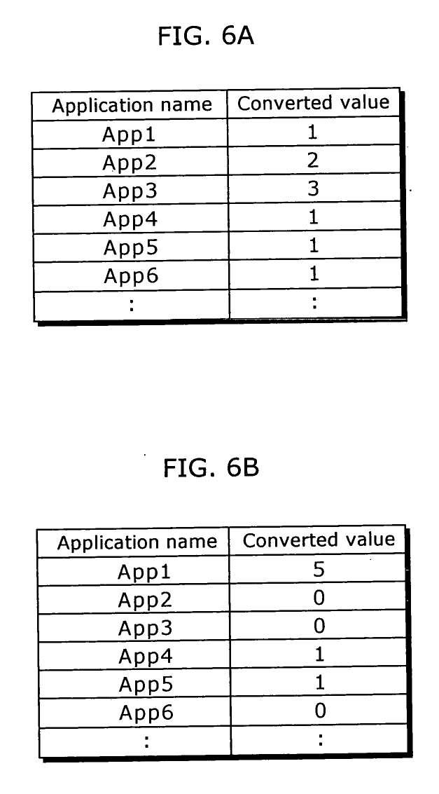

Additionally, the threshold may be determined by means of weighting applications, besides determining by corresponding the thresholds to the number of running applications as explained in the above-mentioned threshold determination step. And more specifically, with regard to the applications with large amount of processing and applications requiring real-time processing, the overload condition detecting unit 25 converts the number of applications from one to weighted number such as two, three and so on, sums up the total number of applications and determines the corresponding threshold. FIG. 6A shows converted values to the respective applications. In the figure, the number of applications for App1, 4, 5 and so on remain one, while the number of applications for App2 is converted to two and the number of applications for App3 is converted to three likewise. This enables to absorb the difference of processing volume for each application and dynamically determine more appropriate thresholds. FIG. 6B shows an example of other converted values. In this example, the number of applications of App1 is converted to five. For instance the threshold value decreases during application 1 being running so that the processing of application 1 can be protected without delay due to data receiving processing.

[Detailed Example of Overload Condition Completion Detecting Processing]

When the overload condition detecting unit 25 detects an overload condition, the overload condition completion detecting unit 26 is activated and executes processing to detect overload condition completion.

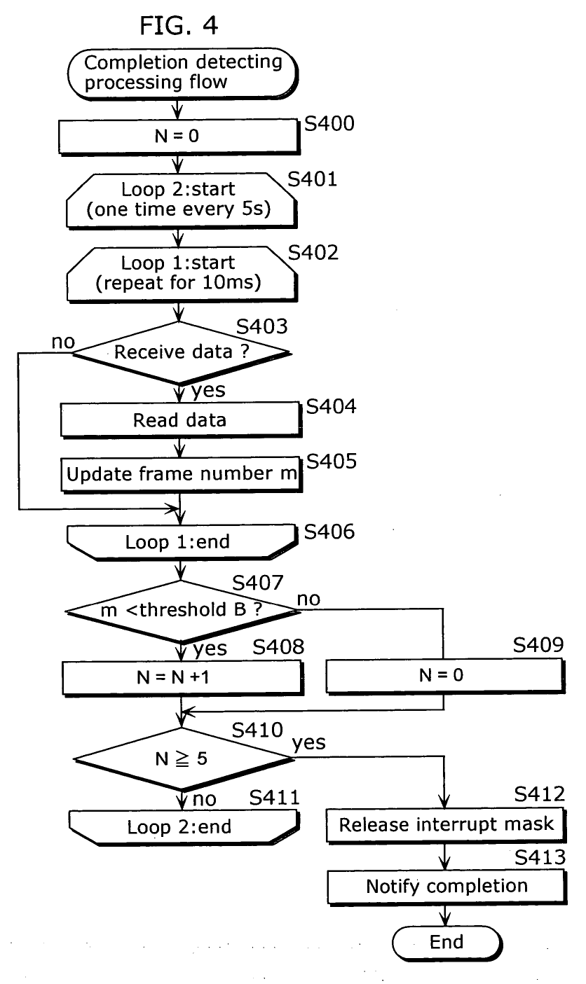

FIG. 4 is a flow chart showing a detailed example of how the overload condition completion detecting unit 26 detects the completion of an overload condition. In the figure, loop 1 is a loop processing of continuous repetition for a predetermined duration (e.g. 10 ms) and loop 2 is a loop processing performed one time for predetermined duration (e.g. 5 seconds). More specifically, the overload condition completion detecting unit 26 performs loop 1 processing of 10 ms every 5 seconds as polling processing. Also N is the value from a counter for counting up from zero to five and the value represents the number of times judged communication overload condition to be solved with high possibility.

At first, the overload condition completion detecting unit 26 initializes the value of the counter to N=0 (S400). And then, the overload condition completion detecting unit 26, as a loop 1 processing, checks whether any data received is being held in the buffer of the LAN chip 14 (S403). When any data is being held, the overload condition completion detecting unit 26 reads the data received (S404), and then counts the number of frames m composed of the data received. This repetition is performed for 10 ms continuously as the loop 1. As a result of this, the number of received frames m is counted for 10 ms.

After the end of the loop 1, the overload condition completion detecting unit 26 judges whether or not the number of received frames m is less than a threshold B (S407). When the number of received frames m is less than the threshold B, N is incremented (N=N+1) (S408) and when the number of received frames m is not less than the threshold B, N is cleared (N=0) (S409). When the number of received frames m is less than the threshold B, it is regarded as the communication overload condition being eliminated with high possibility. The threshold B, for instance, may be set to 85 in the case of transmission speed being 100 Mbps and to 8 in the case of 10 Mbps. The same value as the above-mentioned threshold A may be used, or the value being set dynamically like threshold A shown in FIG. 4 and FIG. 5 may be used as well.

Moreover, the overload condition completion detecting unit 26 judges whether or not N is not less than 5 (S410). In this judgment when the result of loop 1 indicating that an overload condition has been eliminated with high possibility is recognized five straight times, the completion of a communication overload condition is judged.

When the N is judged to be less than 5, the overload condition detecting unit 25 performs one time of the loop 2 processing again after 5 seconds. When the N is judged to be not less than 5, the interrupt mask is released to the interrupt controller 13 (S412), and overload condition completion is notified to the CPU 11 (S413) then the processing is completed.

According to this, the interrupt mask is released and the condition is recovered from an unsteady state to a steady state.

[System Example]

An embodiment where network terminal apparatus (the communication overload condition avoiding apparatus 10) shown in FIG. 1 and FIG. 2 is applied to a home appliance will now be explained.

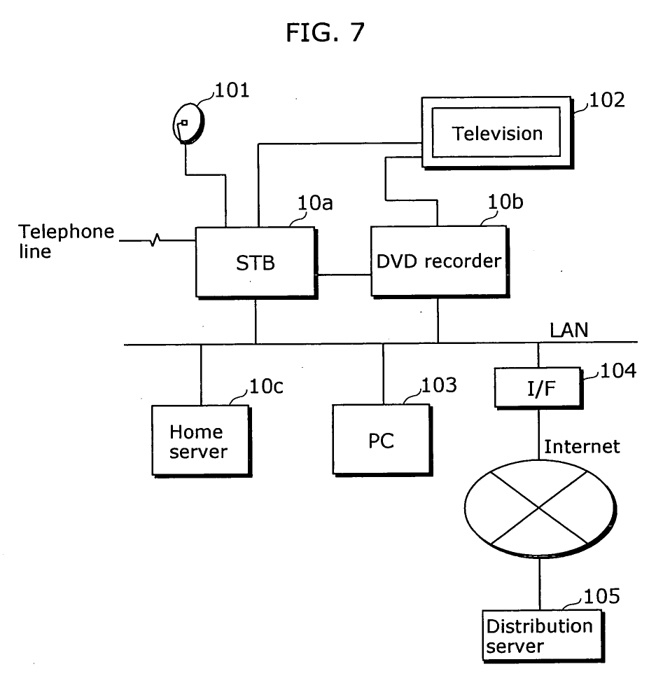

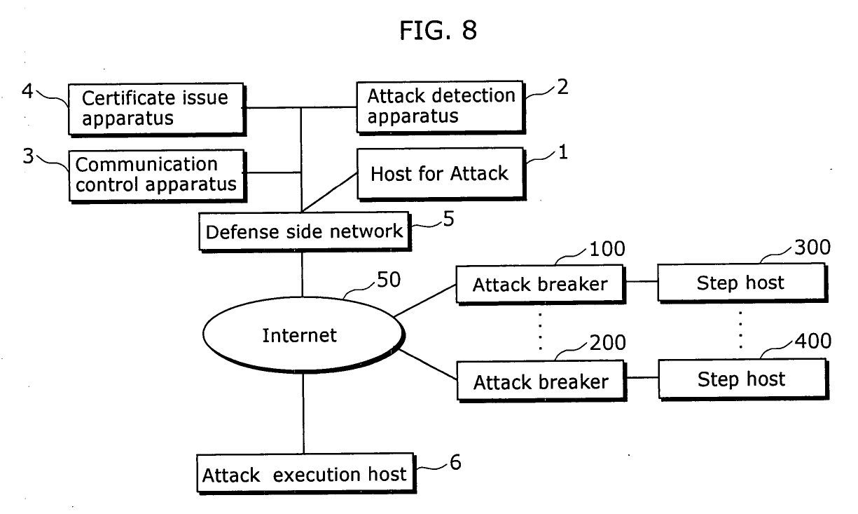

FIG. 7 shows a system example including a home appliance applying a communication overload condition avoiding apparatus 10. In the system of the figure, a set-top box (STB) 10a, a DVD recorder 10b, a home server 10c, a personal computer (PC) 103 and also a network I/F (interface) 104 are all connected to LAN, and further connected to a distribution server 105 on the internet through the network I/F (interface) 104.

Among them, the STB 10a, the DVD recorder 10b and the home server 10c have the configuration of the communication overload condition avoiding apparatus 10 shown in FIG. 1 and FIG. 2 respectively.

The STB 10a performs (1) processing to receive the streaming data sent from digital broadcasting, (2) processing to receive the streaming data sent from one of the home server 10c, the distribution server 105 and so on through LAN, (3) processing to reproduce the streaming data and output the reproduced data to the television 102, (4) processing to send the streaming data on LAN, and so on. Each of processing (1) to (4) all require real-time processing, but (1) and (3) require real-time processing more strictly, while (2) and (4) may be performed in real time by re-transmitting.

For example, the streaming data received in (1) is played in (3), while the streaming data received in (2) is displayed in reduced size on the television 102 in (3).

In this example, a communication overload condition is assumed to be caused by unusually large amount of the data received in (2) or by improper transmission of frames addressed to the STB 10a for some reason. The STB 10a avoids an overload condition by stopping the receiving processing in (2) by means of an interrupt mask on detecting an overload condition. According to this, the processing in (1) and (3) are smoothly performed without delaying reproduction processing or dropping any frame caused by an overload condition.

Also, since the STB 10a is detecting overload condition completion while avoiding overload condition, the condition returns to the original condition after the overload condition being eliminated.

The DVD recorder 10b performs processing chiefly such as (a) processing to receive television broadcasting, (b) processing to receive the streaming data transmitted from the home server 10c or the distribution server 105 through LAN, (c) reproduction the streaming data or processing to output the reproduced data to the television 102, (d) processing to transmit the streaming data to LAN and (e) processing to record DVD. The processing (a) to (d) are approximately the same as aforesaid (1) to (4), while the processing of the DVD recorder 10b is more complex and large volume in terms of performing recording processing (e).

For instance, the video data available from the STB 10a or a built-in tuner (not shown in the figure) is assumed to be under the processing of recording (e) and reproducing in (c) the received streaming data in (b). Real-time processing is required for the recording processing (e) and reproduction processing from (b) to (c) as well, especially recording processing (e) requires real-time processing more strictly.

In this case, detecting, avoiding and recovering from overload condition are executed like above-mentioned STB 10a in the case of a communication overload condition.

The home server 10c stores the streaming data and files in the built-in hard disk and sending and receiving the streaming data or files to and from other apparatuses through LAN. Detecting, avoiding and recovering from overload condition are same as the STB 10a and DVD recorder 10b.

The STB 10a, the DVD recorder 10b and the home server 10c equipping the communication overload condition avoiding apparatus 10 inside respectively are capable of detecting, avoiding and recovering from overload condition by the apparatus alone without external additional devices or user's judgment as shown above.

As explained hereinbefore, since the network terminal apparatus in the present invention invalidates the received data under overload condition, it is possible that elimination of the impact to communication processing and other processing under communication overload condition without user's judgment or additional apparatus. It means that the receiving processing does not occupy the processing capability of the CPU, hence it is possible to continue without degrading the quality of the other processing. Therefore, this is readily applicable to the network terminal apparatus used at home and other processing can be executed smoothly. For instance, as a processing other than communication processing, even the network terminal apparatus executing video data processing requiring real-time processing can eliminate the impact caused by a communication overload condition.

The router used as the network I/F 104 normally blocks an arbitrary sender's address or a protocol set by user and may function to filter to regulate the flow. However this user setting needs a troublesome operation and specialized knowledge. The configuration in the FIG. 7 enables detecting, avoiding and recovering from an overload condition corresponding to flow regulation without any troublesome user's operation.

By contraries, when user sets filtering function, the assigning and the supplementing the functions are enabled by the combination of the filtering function by the network I/F 104 and the individual functions of detecting, avoiding and recovering from overload condition of the STB 10a, the DVD recorder 10b and the home server 10c. The configuration may be arranged as the STB 10a, the DVD recorder 10b and the home server 10c individually enable and disable the functions of detecting, avoiding and recovering from an overload condition in this case.

The same effect can be expected by arranging the configuration as combining two of the arbitrary apparatuses or three of the apparatuses of the STB 10a, the DVD recorder 10b and the home server 10c in FIG. 7 by equipping the communication overload condition avoiding apparatus 10. It is also possible to equip the communication overload condition avoiding apparatus 10 to the personal computer 103.

The overload condition detecting unit 25 measures the amount of the data received reached to the data link layer (LAN chip 14) per unit time, but the measurement result of the amount of the data received reached to the network layer (the IP processing unit 24) per unit time may also be used for the threshold judgment in the configuration. In this case, the overload condition detecting unit 25 can judge whether or not the receiving processing in the network layer (the IP processing unit 24) overflowed, instead of making threshold judgment by measuring the amount of the receiving data reached to the network layer (the IP processing unit 24) per unit time.

Additionally, the overload condition detecting unit 25 may measure the amount of the receiving data in the receiving buffer (in the area of the memory 12), which holding the data received transmitted from the LAN chip 14 temporarily and use the measurement result for the threshold judgment, instead of measuring the amount of the receiving data reached to the data link layer (the LAN chip 14) per unit time.

In the above-mentioned embodiment, the overload condition detecting unit 25 prohibits the notification of the receiving data from the data link layer (the LAN chip 14) to the network layer (the IP processing unit 24) by masking the interrupt signal. Alternatively, it may be configured that the notification of the receiving data or the transmission of the receiving data between the different layers in a communication hierarchy is prohibited. For instance, it may be configured (A) to prohibit the transmission of the receiving data from the physical layer (LAN I/F 15) to the data link layer, or (B) to disable operations any of the physical layer, the data link layer and the network layer.

And also, in the system example in FIG. 7, it may be configured that the overload condition detecting unit 25 notifies an overload condition to the network I/F 104, and the packet addressed to the communication overload condition avoiding apparatus 10 is abandoned (or be filtered) in the network I/F 104, instead of masking the interrupt signal by the overload condition detecting unit 25. In this case, it may be configured that when the network I/F 104 is notified the overload condition, the packets addressed to the communication overload condition avoiding apparatus 10 to be abandoned. The network I/F 104 can determine whether or not the packet being addressed to the communication overload condition avoiding apparatus 10, using, for example, the IP address or the port number of the receiver. In this case the network I/F 104 further equipping the overload condition completion detecting unit 26 and it may be configured that filtering of the packets is stopped when an overload condition completion is detected by the overload condition completion detecting unit 26.

In this configuration, the packets addressed to the communication overload condition avoiding apparatus 10 are abandoned by the network I/F 104 during all the time of communication overload condition of the communication overload condition avoiding apparatus 10. Therefore the apparatuses equipping the communication overload condition avoiding apparatus 10 (e.g. the STB 10a, the DVD recorder 10b and so on) can smoothly execute the primary processing other than communication processing without negative impacts such as processing delay.

Additionally, in the embodiment above, the communication overload condition avoiding apparatus 10 may be equipped with notification unit notifying the user of communication overload condition by means of sound, light, indication and so on under communication overload condition. For example, on the STB 10a and the DVD recorder 10b in FIG. 7, the above-mentioned notification unit may function to indicate the superimposed notification such as “The reception is limited for a while due to a communication overload condition”, “The reception is being limited due to a communication overload condition” and “Recovered from communication overload condition” and so on to the video signal to the television 102 at the each timing of detecting, avoiding and recovering from the communication overload condition.

In the embodiment above, the communication processing on the data link layer is realized by the network driver 23 and the CPU 11, but the particular LSI chip can be used instead of the CPU 11. And also the communication processing (the Internet Protocol processing unit 24) on the network layer is realized by the CPU 11 on the software, but the particular LSI chip can be used instead.

The correspondence between the number of running applications and the thresholds shown in FIG. 5 may be configured to be changeable by remote maintenance from an external apparatus or be changeable by the user setting. In case of the change by the user setting, it may be configured to be selected by users preparing multiple corresponding tables in the network terminal apparatus.

### INDUSTRIAL APPLICABILITY

The present invention is suitable for the network terminal apparatuses to be connected to the network to execute data communication, especially as a network terminal apparatus to be connected to LAN and so on at home, for instance, the network terminal apparatuses such as a Set-Top Box (STB) for receiving digital broadcasting, a digital TV, a Digital Versatile Disc (DVD) recorder, a Hard Disk Drive (HDD) and so on for contents recording and reproduction apparatuses and also the complex equipment of these apparatuses are suitable.

1. A network terminal apparatus, comprising:
a communication unit operable to communicate through a network;
a judgment unit operable to judge whether or not the communication is in an overload condition; and
an invalidation unit operable to invalidate data received by said communication unit in the case where said judgment unit judges that the communication is in an overload condition.

2. The network terminal apparatus according to claim 1,
wherein said judgment unit is operable to judge the communication is in an overload condition in the case where an amount of data received per unit time from the network exceeds a threshold.

3. The network terminal apparatus according to claim 1,
wherein said judgment unit is operable to judge the communication is in an overload condition in the case where an amount of data received in a receiving buffer that temporarily holds the received data exceeds a threshold.

4. The network terminal apparatus according to claim 2,
wherein said judgment unit is operable to compare the received data in communication processing corresponding to a data link layer with the threshold.

5. The network terminal apparatus according to claim 2, further comprising
a determination unit operable to dynamically determine the threshold depending on a load condition of a process other than communication in said network terminal apparatus,
wherein said judgment unit is operable to judge whether or not the communication is in an overload condition using the determined threshold.

6. The network terminal apparatus according to claim 5,
wherein said determination unit is operable to determine the threshold depending on a number of running application programs in said network terminal apparatus.

7. The network terminal apparatus according to claim 6,
wherein said determination unit is operable to determine the threshold depending on (i) the number of running application programs in said network terminal apparatus and (ii) a weight predetermined with respect to each application program.

8. The network terminal apparatus according to claim 1,
wherein said communication unit includes:
a first communication processing unit operable to execute a communication processing corresponding to a physical layer and a data link layer;
a receiving buffer that temporarily holds received data from the first communication processing unit; and
a second communication processing unit operable to take the received data from the receiving buffer and execute communication processing for the received data corresponding to a network layer and the upper layers, and
said judgment unit is operable to judge the communication is in an overload condition in the case where an amount of the received data held in said receiving buffer exceeds the threshold.

9. The network terminal apparatus according to claim 2,
wherein said communication unit is operable to execute hierarchical communication processing, and
said invalidation unit is operable to prohibit one of the interlayer logical connection.

10. The network terminal apparatus according to claim 2,
wherein said communication unit includes:
a first communication processing unit operable to execute communication processing corresponding to a physical layer and a data link layer; and
a second communication processing unit corresponding to a network layer and the upper layers, and
said invalidation unit is operable to prohibit said first communication processing unit from notifying said second communication processing unit of received data.

11. The network terminal apparatus according to claim 1,
wherein said judgment unit includes:
a first detection unit operable to detect that the communication is in an overload condition; and
a second detection unit operable to detect a recovery from the overload condition, and
said network terminal apparatus further comprises
a release unit operable to release the invalidation by said invalidation unit when a recovery from the overload condition is detected.

12. The network terminal apparatus according to claim 11,
wherein said first detection unit is operable to detect that the communication is in an overload condition when an amount of data received per unit time from the network exceeds a first threshold, and
said second detection unit is operable to detect a recovery from the overload condition when an amount of the data received per unit time by said communication unit is below a second threshold, after the overload condition is detected by the first detecting unit.

13. The network terminal apparatus according to claim 12,
wherein said communication unit is operable to execute hierarchical communication processing, and
said invalidation unit is operable to prohibit one of the interlayer logical connection.

14. The network terminal apparatus according to claim 13,
wherein said communication unit includes:
a first communication processing unit operable to execute communication processing corresponding to a physical layer and a data link layer; and
a second communication processing unit corresponding to a network layer and the upper layers,
said first detection unit is operable to judge whether or not the data received by said first communication processing unit exceeds the first threshold,
said invalidation unit is operable to prohibit said first communication processing unit from notifying said second communication processing unit of the received data, and
said second detection unit is operable to check whether an amount of data received by the first communication processing unit is below the second threshold.

15. The network terminal apparatus according to claim 14,
wherein said first communication processing unit is operable to notify said second communication processing unit of received data by an interrupt signal,
said invalidation unit is operable to prohibit the notification by masking the interrupt signal, and
said release unit is operable to release the masking of the interrupt signal.

16. A communication overload avoiding method in a network terminal apparatus including a communication unit operable to communicate through a network, comprising:
judging whether or not communication is in an overload condition; and
invalidating data received by said communication unit in the case where the judgment is that the communication is in an overload condition.

17. The communication overload avoiding method according to claim 16,
wherein, in said judging, it is judged that the communication is in an overload condition in the case where an amount of received data per unit time from a network exceeds a threshold.

18. The communication overload avoiding method according to claim 16,
wherein, in said judging, it is judged that the communication is in an overload condition in the case where an amount of received data in a receiving buffer that temporarily holds the received data exceeds a threshold.

19. The communication overload avoiding method according to claim 17,
wherein, in said judging, the received data in communication processing corresponding to a data link layer is judged using the threshold.

20. The communication overload avoiding method according to claim 17, further comprising
dynamically determining the threshold depending on a load condition of a process other than communication in said network terminal apparatus,
wherein, in said judging, it is judged whether or not the communication is in an overload condition using the determined threshold.

21. The communication overload avoiding method according to claim 20,
wherein, in said determining, the determined threshold is determined depending on a number of running application programs in said network terminal apparatus.

22. The communication overload avoiding method according to claim 21,
wherein said communication unit includes a first communication processing unit operable to execute communication processing corresponding to a physical layer and a data link layer, a receiving buffer that holds data received from the first communication processing unit temporarily and a second communication processing unit operable to take the received data from the receiving buffer and execute communication processing corresponding to a network layer and the upper layers, and
in said judging, it is judged that the communication is in an overload condition in the case where an amount of received data held in said receiving buffer exceeds the threshold.

23. The communication overload avoiding method according to claim 16,
wherein the communication unit is operable to execute hierarchical communication processing, and
in said invalidating, one of the interlayer logical connection is prohibited.

24. The communication overload avoiding method according to claim 16,
wherein said communication unit includes:
a first communication processing unit operable to execute communication processing corresponding to a physical layer and a data link layer; and
a second communication processing unit corresponding to a network layer and the upper layers, and
in said invalidating, said first communication processing unit is prohibited from notifying said second communication processing unit of received data.

25. A program for avoiding a communication overload in a network terminal apparatus including a communication unit that communicates through a network, said program causing a computer in the network terminal apparatus to execute:
judging whether or not communication is in an overload condition; and
invalidating data received by said communication unit in the case where the judgment is that condition is overloaded.
